(19) United States
(12) Patent Application Publication
(10) Pub. No.: US 2005/0225192 A1
(43) Pub. Date: Oct. 13, 2005

(54) Rotor arrangement for an electric machine

(75) Inventors: Markus Kloepzig, Spaichingen (DE); Vladimir Vladimirovich Popov, Villingen-Schwenningen (DE)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: MINEBEA CO., LTD., Kitasaku-gun (JP)

(21) Appl. No.: 11/092,975

(22) Filed: Mar. 30, 2005

(30) Foreign Application Priority Data
Apr. 8, 2004 (DE) 10 2004 017 507.1

(51) Int. Cl. H02K 1/27

(52) U.S. Cl. 310/156.43; 310/156.56

(57) ABSTRACT

A rotor arrangement for an electric machine having a rotor body and permanent magnets embedded in the rotor body, the permanent magnets comprising a large number of individual anisotropic magnets which are arranged and magnetized in the rotor body along lines that correspond at least approximately to a Halbach flux line distribution.

### FIELD OF THE INVENTION

The invention relates to a rotor arrangement for an electric motor having a rotor body and permanent magnets embedded in the rotor body. The rotor arrangement according to the invention can be generally employed in such electric machines as DC motors and generators.

### BACKGROUND OF THE INVENTION

A large variety of electric motors is known on the market, all of which can be classified in various ways, such as according to their structure, their drive mechanism, their control mode, etc. A preferred field of application for the invention is in brushless DC motors and other permanent magnet motors, it being basically known to provide permanent magnets on the outer circumference of a rotor body or to embed them in the rotor body. The invention can further be employed in electric motors and generators that can be configured as inner rotor motors or as outer rotor motors. Electric motors having an inner rotor motor configuration have a rotor arrangement that is mounted onto a shaft and comprises one or more permanent magnets as well as a stator arrangement consisting, for example, of a number of stacked metal laminations which has an annular stator back yoke and pole shoes that protrude inwards from the stator back yoke. Phase windings are mounted on the pole shoes. The rotor arrangement is inserted coaxially into the stator arrangement. In the case of an outer rotor motor configuration, the rotor arrangement encloses the stator coaxially.

It is further known in the prior art to magnetize permanent magnets mounted on the outer circumference of the rotor in such a way that a magnetic flux line distribution conforming to a Halbach magnetization or an approximate Halbach magnetization is produced.

The basic principles of Halbach magnetization are described, for example, in “Halbach Cylinder Servo Motors” by Prof. D. Howe, University of Sheffield, Electrical Machines and Drives Group. Halbach magnetization makes it possible to concentrate the magnetic field generated by the magnets in sine curves. FIGS. 1 and 2 show the Halbach magnetization of a rotor ring for an inner rotor motor and for an outer rotor motor respectively, and the associated magnet flux line distribution. Due to the special flow of flux lines within the rotor, rotors having Halbach magnetization do not need a back iron yoke which can be used to reduce rotor mass and inertia.

It is known to fabricate these kinds of magnetic rings or magnetic cylinders with Halbach magnetization for rotors from either pre-magnetized anisotropic magnetic segments having the required direction of magnetization or from isotropic magnetic rings which are magnetized with Halbach magnetization.

In known rotor arrangements, it is conventional for a segmented permanent magnet ring or several individual permanent magnets to be fixed side by side on a back yoke which is mounted onto the shaft. For motors with a low number of poles, such a multi-pole permanent magnet ring has its disadvantages since the magnet wall has to have a substantial thickness which means that a considerable quantity of magnetic material is needed.

EP 1 263 116 reveals a rotor that has permanent magnets mounted on its outer circumference. The permanent magnets are arranged in the shape of a ring and divided into a large number of segments that are magnetized in such a way as to approximate Halbach magnetization. Although rotor arrangements having Halbach magnetization have numerous advantages, here again the problem arises that, with a low number of poles, the permanent magnet ring on the outer circumference of the rotor is comparatively thick, thus making an excessive amount of magnetic material necessary.

It is the object of the invention to provide a rotor arrangement for an electric machine that can be manufactured at acceptable costs even if the rotor has a low number of poles.

### SUMMARY OF THE INVENTION

This object has been achieved by a rotor arrangement having the characteristics outlined in claim 1. The rotor arrangement according to the invention comprises a rotor body in which permanent magnets are embedded. These permanent magnets consist of a large number of individual anisotropic magnets which are arranged and magnetized in the rotor body along lines that correspond at least approximately to a Halbach flux line distribution. The design of the permanent magnets according to the invention makes it possible to significantly reduce the volume of magnetic material and thus the costs for the magnets compared to rotor arrangements having annular permanent magnets, particularly for rotors having a low number of poles. The arrangement and magnetization of the individual magnets along Halbach flux lines allows a Halbach magnetization of the permanent magnets to be achieved, so that ideally the rotor body can be constructed, for example, from a plastic carrier in which the individual magnets are accommodated without the need of an intermediary back yoke. This goes to reduce the costs of the rotor. Moreover, the mass and inertia of a rotor having a plastic carrier is lower than that of a rotor having an iron back yoke.

In a preferred embodiment of the invention, the plastic carrier can be given pockets to accommodate the individual magnets. It is advantageous if these pockets have projections in an axial and/or radial direction which engage with the individual magnets in order to position the magnets and to hold them in this position without play while evening out tolerances.

In another embodiment of the invention, the individual magnets can also be injection molded into the plastic carrier which means that the magnets need not be individually mounted and that the individual magnets can be positioned accurately.

In another extremely beneficial embodiment of the invention, each pole pair formed by the permanent magnets is made up of a plurality of individual magnets which essentially have the same shape, size and direction of magnetization. It is advantageous if these individual magnets are simple cuboidal magnets that are magnetized in a longitudinal direction and arranged along the theoretic Halbach flux lines in such a way that goes to produce a Halbach magnetization of the rotor. This embodiment makes it possible to achieve the desired Halbach magnetization using very simple, low-cost individual magnets.

In another embodiment of the invention each pole pair formed by the permanent magnets can be made up of one individual magnet, this individual magnet preferably being curved along a line that essentially corresponds to the theoretic flow of Halbach flux lines.

The individual magnets can be pre-aligned in a preferred direction, the magnets being magnetized in the rotor body after their assembly.

In a further embodiment of the invention, a plurality of individual magnets is arranged side by side in the longitudinal direction of the shaft. This makes it possible to improve the overall performance of the rotor magnets. It is further possible to offset the angular position of these individual magnets, arranged side by side in the longitudinal direction of the shaft, with respect to each other in order to create a skew in the magnetic field distribution, which goes, for example, to further reduce cogging torque.

In this embodiment, the rotor body can consist of a plastic carrier made up of a basic body and at least one additional body, the basic body and the additional body being arranged side by side in the longitudinal direction of the shaft in order to accommodate the individual magnets lying next to each other. It is basically possible to connect the basic body and the additional body as well as a cover for these using spring-loaded latches.

In an embodiment of the invention, the rotor body is designed with a plastic carrier that is mounted in a positive-fit on the shaft. In another embodiment of the invention, the plastic carrier is injection molded directly onto the shaft. The plastic carrier is designed so that it has a thin plastic layer on its outer surface which covers and protects the magnets from the outside. To reinforce this plastic layer located between the magnets and the air gap of the motor, reinforcing ribs can be formed on the thin plastic layer.

### SHORT DESCRIPTION OF THE DRAWINGS

The invention is described in more detail below on the basis of preferred embodiments with reference to the drawings. The figures show:

FIG. 1 and 2 Halbach magnetization of a rotor ring and the associated flux line distribution for an inner rotor motor (FIG. 1) and for an outer rotor motor (FIG. 2) respectively;

FIG. 3 a schematic view of a magnetic ring for a rotor arrangement having multi-pole Halbach magnetization;

FIG. 4 a schematic partial view of an electric motor having a rotor arrangement according to an embodiment of the invention;

FIG. 5 a schematic partial view of a further embodiment of a rotor arrangement according to the invention;

FIG. 6 a schematic sectional view through a plastic carrier for a rotor body according to a first embodiment;

FIG. 7 a schematic sectional view through a plastic carrier for a rotor body according to a second embodiment.

### DESCRIPTION OF PREFERRED EMBODIMENTS

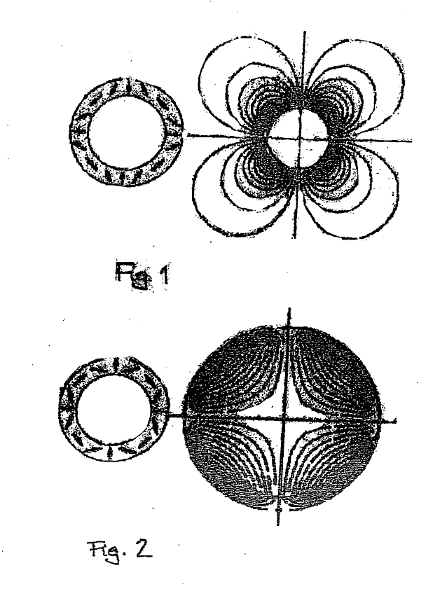

FIG. 1 and 2 show the magnetization and the corresponding flux line distribution for the permanent magnet ring of a rotor arrangement according to an inner rotor motor configuration (FIG. 1) and an outer rotor motor configuration (FIG. 2) respectively. In the case of a Halbach magnetization, the flux line distribution in the air gap between rotor and stator is inherently sine shaped, as a result of which theoretical minimum cogging torque is achieved and an essentially sine-shaped EMF waveform is produced. Since, due to the Halbach magnetic arrangement, the magnetic flux within the rotor is led through the magnets with hardly any leakage flux and thus practically shielded from one side, the permanent magnet ring can be mounted onto a rotor body that does not need an iron back yoke, as can be seen from the flux line distribution in FIG. 1 and 2.

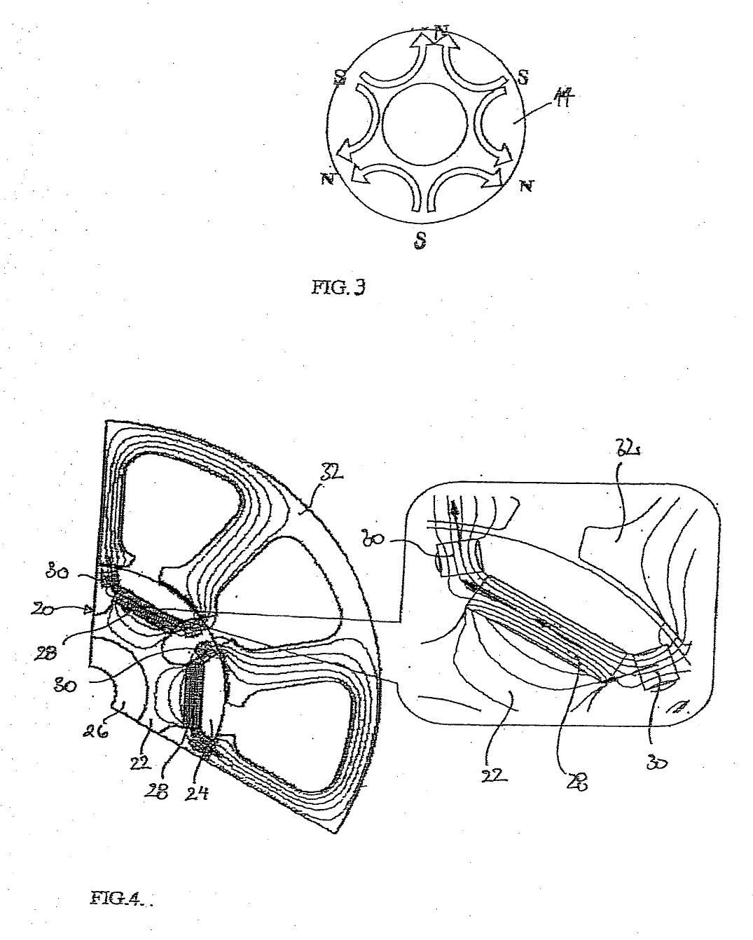

FIG. 3 schematically shows the multi-pole magnetization of a magnetic ring 14 of a rotor arrangement having Halbach magnetization. As can be seen from FIG. 3, a rotor arrangement of this type having a low number of poles needs a relatively thick magnetic ring in order to generate the desired flow of Halbach flux lines.

FIG. 4 shows a partial view of an electric motor having a rotor arrangement according to the invention. The rotor arrangement comprises a rotor body 20 that, in the illustrated embodiment, has a magnet carrier 22 and a plastic carrier 24. The magnet carrier 22 can be made of metal; it can, but need not, have magnetic properties. The magnet carrier is used to mount the rotor body 20 onto a shaft 26 as well as to hold and position the plastic carrier 24 and the permanent magnets 28, 30 embedded in the plastic carrier. The magnets 28, 30 can be injection molded into the plastic carrier 24 in which case, for the sake of expedience, the magnet carrier 22 together with the magnets can be set in the injection molding die during manufacture of the rotor arrangement in order to create an integral rotor body 20. However, the plastic carrier 24 can also be designed in such a way that it secures the magnets 28, 30 to the magnet carrier 22 in pockets provided for this purpose, as described once more below. In another embodiment of the invention, the rotor body 20 can be entirely formed from a plastic part without a separate magnet carrier being provided.

The rotor body 20 is coaxially inserted into a stator 32.

According to the invention, the permanent magnets 28, 30 are embedded in the rotor body 20 in such a way that they are at least approximately aligned and magnetized along the theoretic Halbach magnetic flux lines. This is made clear with reference to the enlarged view on the right-hand side of FIG. 4. In the illustrated embodiment, for each rotor pole, an oblong cuboidal magnet 28 as well as two small cubic magnets 30, i.e. in the form of parallel-epipeds, are provided. The directions of magnetization are indicated by arrows. The magnetic flux line distribution resulting between the rotor 20 and the stator 32 is further shown in FIG. 4. This corresponds to an approximate Halbach magnetic field distribution. The actual magnetization of the rotor body can be optimized by the appropriate choice and arrangement of the individual magnets 28, 30.

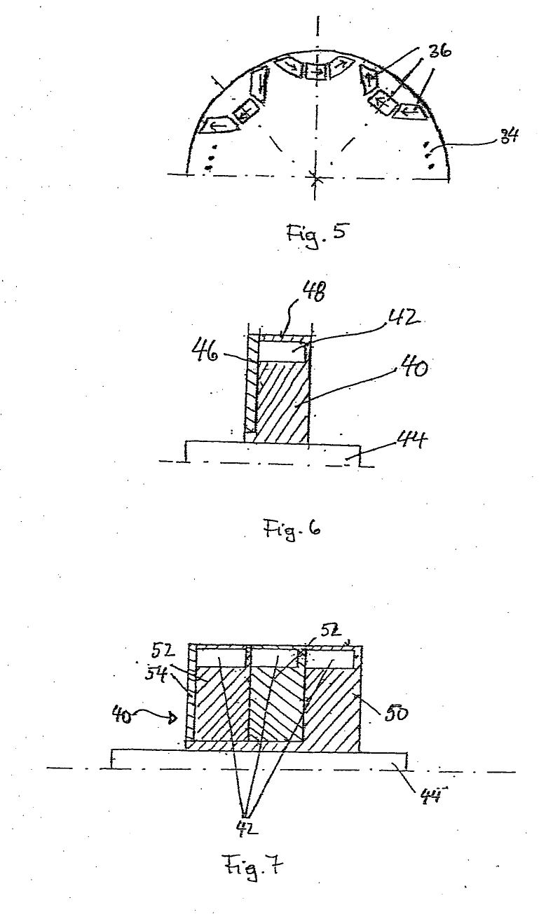

FIG. 5, for example, schematically shows a rotor arrangement 34 in which each magnetic pole is realized by using three essentially identical individual magnets 36 that are arranged and magnetized along the theoretic Halbach magnetic flux lines. By dividing the magnets into an even greater number of individual magnets, an even closer approximation of the flow of the magnetic flux lines can be achieved. It is also possible to realize each pole of the rotor arrangement by using a single, appropriately curved and magnetized permanent magnet. The arrangement according to the invention of the permanent magnets in the rotor body makes it possible to achieve at least an approximate Halbach magnetization using a minimum of magnetic material, thus making it possible to replace the thick permanent magnet rings required especially for rotors having low numbers of poles with considerably more cost-effective arrangements.

FIG. 6 schematically shows a sectional view through a plastic carrier 40 to accommodate an individual magnet in a recess 42. The plastic carrier 40 is mounted onto a shaft 44 in a positive-fit or injection molded onto the shaft. It is sealed by a cover 46. The plastic carrier shown in FIG. 6 represents a particularly simple realization of the rotor arrangement according to the invention in which the individual magnets can be simply placed into the plastic carrier and are then precisely positioned and held by the plastic carrier. Projections 42 (not illustrated) can be provided along the walls of the recess 42 in order to set the magnets in the required position and to even out tolerances during production. Projections can be provided in particular for radial and axial positioning. The outside wall 48 of the plastic carrier 40 that separates the magnets from the air gap should be as thin as possible, but can have ribs (not illustrated) for reinforcement purposes.

FIG. 7 shows a similar view as in FIG. 6, the plastic carrier in this embodiment being designed in such a way that it can accommodate a plurality of individual magnets lying side by side in an axial direction in appropriate recesses 42. For this purpose, the plastic carrier comprises a basic body 50 and, in the illustrated embodiment, two additional bodies 52 which are held on the basic body 50. A cover is indicated by 54. The basic body 50 can in turn be injection molded onto the shaft 44 or fixed to it in a positive-fit. The basic body 50 and the additional bodies 52 have recesses 42 to accommodate the individual magnets. The basic body 50, additional bodies 52 and the cover 54 can be connected to each other using spring-loaded latches. Moreover, they can be designed so that the plastic body accommodates the individual magnets lying side by side or at an offset angle to provide a skew in the permanent magnets with the aim of reducing cogging torque even more.

The embodiment of the rotor arrangement according to the invention having the plastic carrier has the advantage that the rotor arrangement has a precise geometry and can be easily manufactured, for example, by injection molding. Since an iron back yoke is not necessary or, where applicable, can be embedded in the plastic carrier, no, or only very low, thermal tensions are created in the magnets so that there is no risk of breakage for the magnets. A particularly simple embodiment is produced if the plastic carrier is injection molded directly onto the shaft. Moreover, the plastic carrier is variable in a way that the performance of the rotor and/or a skew of the rotor can be achieved by stacking several carrier components. The arrangement according to the invention is suitable for both low numbers as well as high numbers of poles. Despite the use of individual magnets with a simple magnetic form, it is still possible to achieve Halbach magnetization.

The characteristics revealed in the above description, the claims and the figures can be important for the realization of the invention in its various embodiments both individually and in any combination whatsoever.

### IDENTIFICATION REFERENCE LIST

14 Magnetic ring
20 Rotor body
22 Magnet carrier
24 Plastic carrier
26 Shaft
28, 30 Permanent magnets
32 Stator
34 Rotor arrangement
36 Individual magnet
40 Plastic carrier
42 Recess
44 Shaft
46 Cover
48 Outside wall
50 Basic body
52 Additional body
54 Cover

1. A rotor arrangement for an electric machine having a rotor body and permanent magnets embedded in the rotor body, the permanent magnets comprising a large number of individual anisotropic magnets which are arranged and magnetized in the rotor body along lines that correspond at least approximately to a Halbach flux line distribution.

2. A rotor arrangement according to claim 1, wherein the rotor body comprises a plastic carrier in which the individual magnets are accommodated.

3. A rotor arrangement according to claim 2, wherein the plastic carrier has pockets to accommodate the individual magnets.

4. A rotor arrangement according to claim 3, wherein the pockets have projections which engage with the individual magnets.

5. A rotor arrangement according to claim 2, wherein the individual magnets are injection molded into the plastic carrier.

6. A rotor arrangement according claim 1, wherein each pole pair formed by the permanent magnets is made up of a plurality of individual magnets.

7. A rotor arrangement according to claim 6, wherein the individual magnets have essentially the same shape, size and direction of magnetization.

8. A rotor arrangement according to claim 7, wherein the individual magnets are essentially cuboidal.

9. A rotor arrangement according to claim 1, wherein each pole pair formed by the permanent magnets is made up of one individual magnet.

10. A rotor arrangement according to claim 9, wherein the individual magnets are curved along a line which essentially corresponds to a Halbach flux line distribution.

11. A rotor arrangement according to claim 1, wherein several individual magnets are arranged side by side in the longitudinal direction of the shaft.

12. A rotor arrangement according to claim 11, wherein the angular positions of the individual magnets arranged side by side in the longitudinal direction of the shaft are offset to create a skew in the magnetic field distribution.

13. A rotor arrangement according to claim 11, wherein the rotor body comprises a plastic carrier having a basic body and at least one additional body that are arranged side by side in the longitudinal direction of the shaft.

14. A rotor arrangement according to claim 1, wherein the rotor body comprises a plastic carrier that is mounted onto the shaft in a positive-fit.

15. A rotor arrangement according to claim 1, wherein the rotor body comprises a plastic carrier that is injection molded onto the shaft.

16. A rotor arrangement according to claim 14, wherein the plastic carrier has a thin plastic layer on its outer surface that separates the magnets from the environment and that the plastic layer has reinforcing ribs.

17. A rotor arrangement according to claim 15, wherein the plastic carrier has a thin plastic layer on its outer surface that separates the magnets from the environment and that the plastic layer has reinforcing ribs.

18. A rotor arrangement according to claim 2, wherein the plastic carrier, together with the magnets it accommodates, is mounted onto the shaft without an intermediary back yoke.

19. A permanent magnet motor having a rotor arrangement comprising a rotor body and permanent magnets embedded in the rotor body, the permanent magnets comprising a large number of individual anisotropic magnets which are arranged and magnetized in the rotor body along lines that correspond at least approximately to a Halbach flux line distribution.

20. The permanent magnet motor of claim 19, wherein the rotor body comprises a plastic carrier in which the individual magnets are accommodated.
